(19) United States
(12) Patent Application Publication
(10) Pub. No.: US 2024/0256898 A1
(43) Pub. Date: Aug. 1, 2024

(54) TECHNIQUES FOR USING RELAY AVERAGING IN FEDERATED LEARNING

(71) Applicant: QUALCOMM Incorporated, San Diego, CA (US)

(72) Inventors: Yuwei REN, Beijing (CN); Huilin XU, Temecula, CA (US); June NAMGOONG, San Diego, CA (US)

(21) Appl. No.: 18/566,014

(22) PCT Filed: Sep. 1, 2021
(86) PCT No.: PCT/CN2021/115880

§ 371 Date: Nov. 30, 2023

(51) Int. Cl. G06N 3/098

(52) U.S. Cl. CPC G06N 3/098

(57) ABSTRACT

Some aspects described herein relate to receiving, from each of multiple UEs in sidelink communications, a report of a model update for a federated learning model, generating, based on one or more parameters in the report of the model update received from each of the multiple UEs, a converged model update, and transmitting, to an upstream node, the converged model update. Other aspects relate to receiving, from a base station, an indication of a federated learning model, generating, for the federated learning model and based on a local training on the federated learning model, a model update to be applied to the federated learning model, and transmitting, to a relay UE in sidelink communication, a report of the model update.

### BACKGROUND

Aspects of the present disclosure relate generally to wireless communication systems, and more particularly, to scheduling sidelink communications.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable low-latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

In some wireless communication technologies, such as 5G, user equipment (UEs) communicate over one or more of multiple interfaces. The multiple interfaces may include a Uu interface between the UE and a base station, where the UE can receive communications from the base station over a downlink and transmit communications to the base station over an uplink. In addition, the multiple interfaces may include a sidelink interface to communicate with one or more other UEs directly over a sidelink channel (e.g., without traversing the base station). In addition, federated learning concepts have been introduced where UEs can be used to perform updates to network learning models and communicate the updates to the network.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, a memory configured to store instructions, and one or more processors communicatively coupled with the memory and the transceiver. The one or more processors are configured to execute the instructions to cause the apparatus to receive, from each of multiple user equipment (UEs) in sidelink communications, a report of a model update for a federated learning model, generate, based on one or more parameters in the report of the model update received from each of the multiple UEs, a converged model update, and transmit, to an upstream node, the converged model update.

In another aspect, an apparatus for wireless communication is provided that includes a transceiver, a memory configured to store instructions, and one or more processors communicatively coupled with the memory and the transceiver. The one or more processors are configured to execute the instructions to cause the apparatus to receive, from a base station, an indication of a federated learning model, generate, for the federated learning model and based on a local training on the federated learning model, a model update to be applied to the federated learning model, and transmit, to a relay UE in sidelink communication, a report of the model update.

In another aspect, a method for wireless communication by a user equipment UE is provided that includes receiving, from each of multiple UEs in sidelink communications, a report of a model update for a federated learning model, generating, based on one or more parameters in the report of the model update received from each of the multiple UEs, a converged model update, and transmitting, to an upstream node, the converged model update.

In another aspect, a method for wireless communication by a UE is provided that includes receiving, from a base station, an indication of a federated learning model, generating, for the federated learning model and based on a local training on the federated learning model, a model update to be applied to the federated learning model, and transmitting, to a relay UE in sidelink communication, a report of the model update.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a user equipment (UE), in accordance with various aspects of the present disclosure;

FIG. 3 is a block diagram illustrating an example of a base station, in accordance with various aspects of the present disclosure;

FIG. 4 is a flow chart illustrating an example of a method for performing local updating of a federated learning (FL) model, in accordance with various aspects of the present disclosure;

FIG. 5 is a flow chart illustrating an example of a method for generating and transmitting an averaged model update, in accordance with various aspects of the present disclosure;

FIG. 6 illustrates a call flow between various nodes in a wireless network, in accordance with various aspects of the present disclosure;

FIG. 7 illustrates an example of a wireless network for FL model updating, in accordance with various aspects of the present disclosure; and

FIG. 8 is a block diagram illustrating an example of a MIMO communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to using a relay user equipment (UE) to collect federated learning model updates from multiple other UEs, and send the updates, or an averaged update, or one or more other updates representative of the model updates from the multiple UEs, to an upstream node. For example, the upstream node can be a component of the wireless network (e.g., base station), another relay UE, etc. Federated learning can include data transmission between server (e.g., one node defined in network and gNB) and distributed users (e.g., UEs, which can include mobile, vehicle-based, or others). Federated learning can overcome the data privacy concern by sharing the model among nodes, but not the underlying data used to update the model.

In an example of federated learning, the server can share, via downlink signaling, a global model, M₀, to the scheduled users (e.g., UE). A given user can independently make model training based on its own local data. The given user (e.g., UE) can report the updated model via uplink signaling. For example, different UEs can report updated models {\hat{M}₀⁰, \hat{M}₀¹, \hat{M}₀² . . . }, e.g., for UEs 0, 1, 2, . . . , respectively. The server can converge the updated models to generate a new global model, M₁. The convergence mechanism may include applying convergence weights for different model updates, such as α,β, γ for UEs 0, 1, 2, respectively, such that the new global model can be determined as M₁=a\hat{M}₀⁰+B\hat{M}₀¹+γ\hat{M}₀²+ . . . . The server can, in some aspects also broadcast the new updated global model, M₁, for all users.

Some challenges in federated learning (FL) can include large size of the base model, (which can include a machine learning (ML) model), the number of FL models, frequency FL events (e.g., frequency updates to the FL model from various UEs), limited uplink resources in configured slots for transmitting FL updates, etc. Additional challenges may arise for low-tier UEs, which may be scheduled for FL in downlink, but the low-tier device may have uplink coverage constraints and power limitations. Accordingly, aspects described herein relate to UEs establishing sidelink communications with relay UEs to communicate model updates, where the relay UEs can average or otherwise converge model updates from the various UEs for providing to another upstream node. This can conserve uplink resources used to report the FL model updates, improve throughput for UEs that may have UL coverage constraints or power limitations by allowing these UEs to instead communicate with nearby relay UEs using sidelink, and/or the like. This may improve overall throughput of federated learning communications among various nodes in the wireless network, which can improve accuracy of the model at any given point in time (e.g., by reducing latency to update).

In one example, UEs and relay UEs can communicate using sidelink (SL) communications in multiple time periods or time divisions, such as multiple slots, mini-slots, etc. For example, SL communications can refer to device-to-device (D2D) communication among devices (e.g., user equipment (UEs)) in a wireless network. In a specific example, SL communications can be defined for vehicle-based communications, such as vehicle-to-vehicle (V2V) communications, vehicle-to-infrastructure (V2I) communications (e.g., from a vehicle-based communication device to road infrastructure nodes), vehicle-to-network (V2N) communications (e.g., from a vehicle-based communication device to one or more network nodes, such as a base station), a combination thereof and/or with other devices, which can be collectively referred to as vehicle-to-anything (V2X) communications. In V2X communications, vehicle-based communication devices can communicate with one another and/or with infrastructure devices over a SL channel.

For example, a slot can include a collection of multiple symbols, where the multiple symbols can be one of orthogonal frequency division multiplexing (OFDM) symbols, single carrier-frequency division multiplexing (SC-FDM) symbols, or other types of symbols. In an example, the number of symbols in a slot may vary based on a cyclic prefix (CP) length defined for the symbols. A mini-slot, in an example, can include a portion of a slot, and thus a slot can include multiple mini-slots. In one example, UE can transmit SL communications in the slot or mini-slot, where a transmission time interval (TTI) can be the slot, the mini-slot, or each symbol within the slot or mini-slot.

Continued support and implementation of SL communications is provided in fifth generation (5G) new radio (NR) communication technologies. 5G NR defines SL Mode 1, where a SL transmitting UE can receive a scheduling grant from a gNB that schedules the frequency and/or time resources for SL transmission by the SL transmitting UE (e.g., PSCCH and/or PSSCH resources). 5G NR also defines SL Mode 2, where a SL transmitting UE can select resources for SL transmission from a resource pool, where the resource pool may be configured by the gNB.

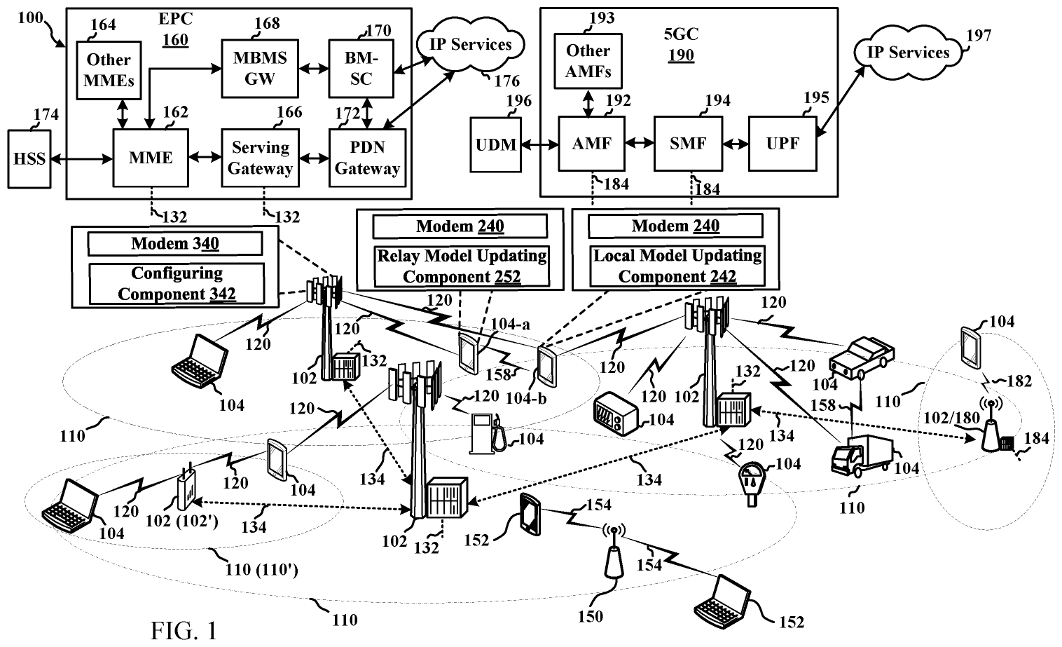

The described features will be presented in more detail below with reference to FIGS. 1-8.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and local model updating component 242 for performing local updating of a FL model, as described further herein. In addition, some nodes of the wireless communication system may have a modem 240 and relay model updating component 252 for performing converging local model updates of the FL model received from one or more other nodes, as described further herein. In addition, some nodes may have a modem 340 and configuring component 342 for configuring UEs with a base FL model, receiving FL model updates, etc., as described herein. Though UE 104-b is shown as having the modem 240 and local model updating component 242, UE 104-a is shown as having the modem 240 and relay model updating component 252 and a base station 102 is shown as having the modem 340 and configuring component 342, this is one illustrative example, and substantially any node or type of node may include a modem 240 and local model updating component 242, modem 240 and relay model updating component 252, and/or a modem 340 and configuring component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs (e.g., UE 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network. In addition, in this regard, UEs 104-a, 104-b can use a portion of frequency in the 5 GHz unlicensed frequency spectrum in communicating with the small cell 102′, with other cells, with one another using sidelink communications, etc. The UEs 104-a, 104-b, small cell 102′, other cells, etc. can use other unlicensed frequency spectrums as well, such as a portion of frequency in the 60 GHz unlicensed frequency spectrum.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, configuring component 342 can transmit, via modem 340, a base FL model to one or more UEs to be locally trained at the UEs and updates reported back to the base station 102. At least UE 104-b can receive the base FL model from the base station 102 (or from UE 104-a as a relay UE). Local model updating component 242 can perform local updating of the FL model based on data obtained by UE 104-b. In this example, after a period of time or based on one or more triggers or a request from the base station 102, local model updating component 242 can transmit its locally updated version of the FL model to UE 104-a as a relay UE over sidelink communications. In an example, UE 104-a can receive locally updated versions of the FL model from multiple different UEs, and can generate and transmit an averaged or otherwise converged updated version of the FL model to the base station 102. As described, this can conserve uplink resources and signaling associated with transmitting the FL model updates, and/or can enable UEs with uplink coverage constraints or power limitations to participate in FL model updating.

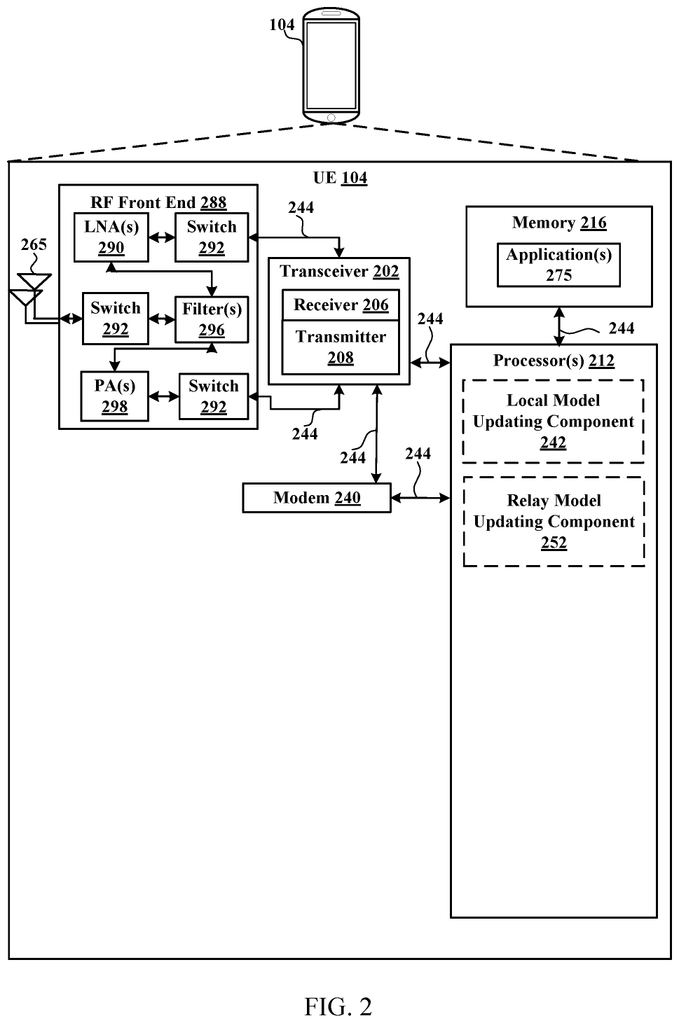

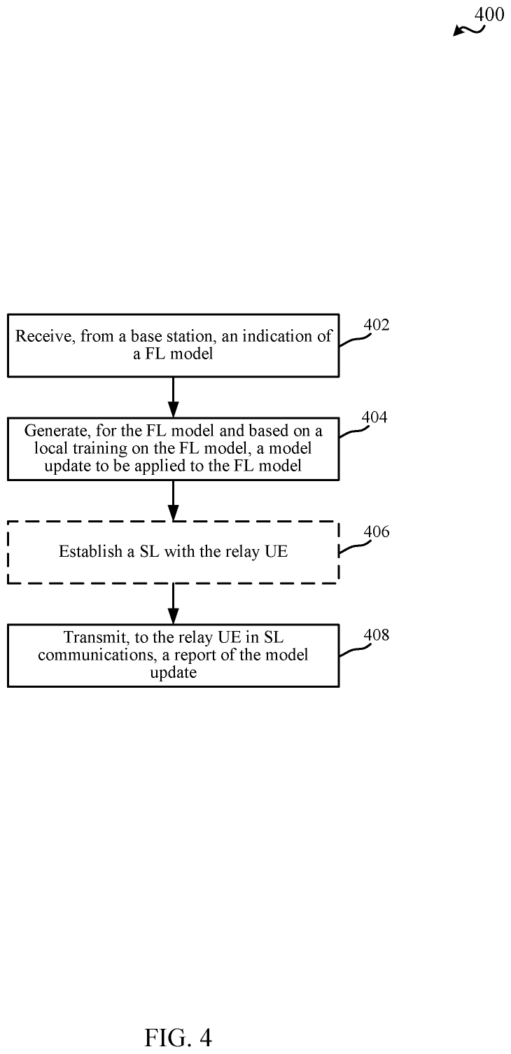

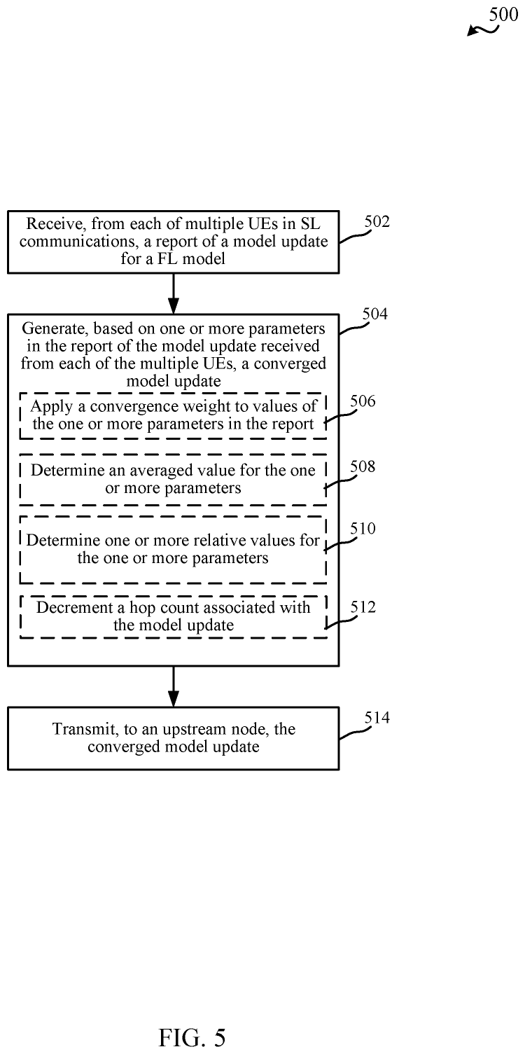

Turning now to FIGS. 2-8, aspects are depicted with reference to one or more components and one or more methods that may perform the actions or operations described herein, where aspects in dashed line may be optional. Although the operations described below in FIGS. 4-5 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or local model updating component 242 for performing local updates to a FL model and transmitting the locally updated FL model to one or more relay UEs, as described herein. In another example, one or more processors 212 and memory 216 and transceiver 202 in communication via one or more buses 244 may operate in conjunction with modem 240 and/or relay model updating component 252 for receiving local updates to a FL model from multiple UEs and transmitting an averaged or converged updated FL model to base station, as described herein. In an example, a given UE may include one of the local model updating component 242 or the relay model updating component 252. In another example, a given UE may be capable of local model training and being a relay UE, and thus may include both of the local model updating component 242 and the relay model updating component 252.

In an aspect, the one or more processors 212 can include a modem 240 and/or can be part of the modem 240 that uses one or more modem processors. Thus, the various functions related to local model updating component 242 or relay model updating component 252 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with local model updating component 242 or relay model updating component 252 may be performed by transceiver 202.

Also, memory 216 may be configured to store data used herein and/or local versions of applications 275 or local model updating component 242 or relay model updating component 252 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining local model updating component 242 or relay model updating component 252 and/or one or more of its subcomponents, and/or data associated therewith, when UE 104 is operating at least one processor 212 to execute local model updating component 242 or relay model updating component 252 and/or one or more of its subcomponents.

Transceiver 202 may include at least one receiver 206 and at least one transmitter 208. Receiver 206 may include hardware and/or software executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102 or a SL transmitting UE. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware and/or software executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, receiving wireless communications transmitted by at least one base station 102 or a SL transmitting UE, transmitting wireless communications to at least one base station 102 or a SL receiving UE, etc. RF front end 288 may be connected to one or more antennas 265 and can include one or more low-noise amplifiers (LNAs) 290, one or more switches 292, one or more power amplifiers (PAS) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102, one or more other UEs in SL communications, etc. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

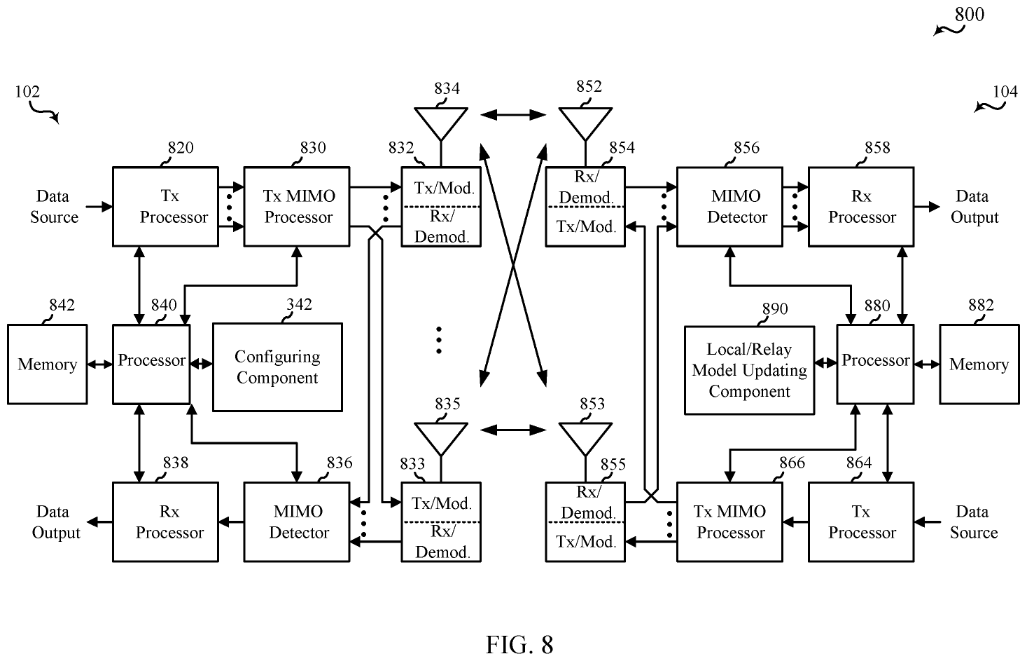

In an aspect, the processor(s) 212 may correspond to one or more of the processors described in connection with the UE in FIG. 8. Similarly, the memory 216 may correspond to the memory described in connection with the UE in FIG. 8.

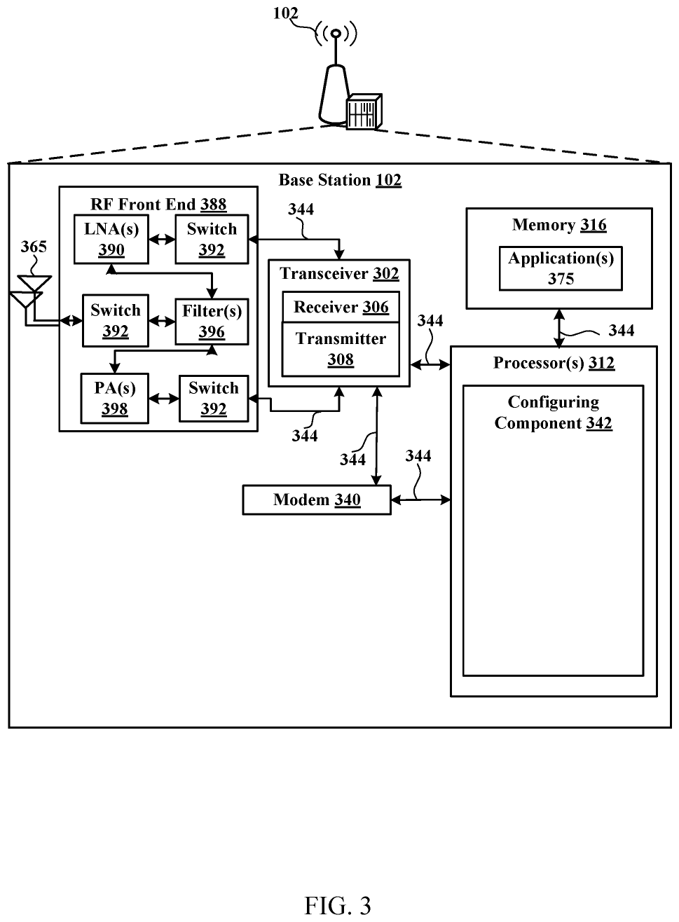

Referring to FIG. 3, one example of an implementation of base station 102 (e.g., a base station 102 and/or gNB 180, as described above) may include a variety of components, some of which have already been described above, but including components such as one or more processors 312 and memory 316 and transceiver 302 in communication via one or more buses 344, which may operate in conjunction with modem 340 and configuring component 342 for configuring UEs with a base FL model, receiving FL model updates, etc., as described herein.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of UE 104, as described above, but configured or otherwise programmed for base station operations as opposed to UE operations.

In an aspect, the processor(s) 312 may correspond to one or more of the processors described in connection with the base station in FIG. 8. Similarly, the memory 316 may correspond to the memory described in connection with the base station in FIG. 8.

FIG. 4 illustrates a flow chart of an example of a method 400 for performing local updating of a FL model. In an example, a UE (e.g., UE 104-b) can perform the functions described in method 400 using one or more of the components described in FIGS. 1 and 2.

In method 400, at Block 402, an indication of an FL model can be received from a base station. In an aspect, local model updating component 242, e.g., in conjunction with processor(s) 212, memory 216, transceiver 202, etc., can receive, from the base station (e.g., base station 102), the indication of the FL model. For example, configuring component 342 of a base station 102 can transmit a base FL model to various UEs for performing FL updating of the base FL model. As described, the FL model can be a ML model based on which various UEs can perform local model updating procedures and the local updates can be communicated back for updating the global base FL model. In an example, local model updating component 242 can receive the indication of the FL model in downlink signaling from the base station 102, such as radio resource control (RRC) signaling, over a physical downlink control channel (PDCCH), over a physical downlink shared channel (PDSCH), and/or the like. In addition, for example, the indication of the FL model may include a link to the FL model, that actual FL model data, and/or the like. In any case, local model updating component 242 can receive from the base station, or otherwise obtain, the FL model for performing local training.

In method 400, at Block 404, a model update to be applied to the FL model can be generated, for the FL model and based on local training on the FL model. In an aspect, local model updating component 242, e.g., in conjunction with processor(s) 212, memory 216, transceiver 202, etc., can generate, for the FL model and based on local training on the FL model, the model update to be applied to the FL model. For example, the UE can perform local training on the model based on data known by, or received by, the UE. In one example, the FL model can correspond to a ML model based on actions or content stored at the UE, and the UE can train the ML model based on its own update. In FL, the updates from various UEs can be collected and applied to the base model. As described, for example, local model updating component 242 can determine to generate the model update after a period of time from receiving the base FL model from the base station 102, based on a trigger or event, based on a request from the base station 102 or relay UE for the model update, etc. In an example, the base station 102 can configure the parameters specifying when the UE is to generate the model update.

In generating the model update, local model updating component 242 can include parameters corresponding to the updated FL model, such as a model index identifying the FL model, one or more model parameters and corresponding values, an accepted hop count for hopping the model update among relay UEs, a convergence weight to apply to the values of the one or more model parameters, etc. In a specific example, the model update may be a message having a format similar to the following:

```
RL message from scheduled UE:
{....
        Model index: N bit, optional [0,1,2,3..]
        Parameters:
          {first conv layer: values,
          second conv layer: values,
          ...
          first FL layers: values,
        }
        Hop count: 8, optional [0,1,2,..,max-Hop]
        Convergence weight: N bit, optional[1,2,3,..]
....}
```

where N bit can be leveraged to indicate what is the model index in the FL, the parameters may be one dictionary, including the parameter names and the corresponding values, the hop count may constrain how many times the message can be hopped (e.g., value 8 means the message at most can be hopped 8 times), the convergence weight can be used for the model convergence. For example, for the hop count, as described further herein, if a current relay hops the message to another relay, reduce hop count, e.g., from 8 to 7. For the convergence weight, in one example, the default can be 1, which means this updated model is with normal priority, and a higher value can correspond to the higher priority.

In method 400, optionally at Block 406, a SL can be established with the relay UE. In an aspect, local model updating component 242, e.g., in conjunction with processor(s) 212, memory 216, transceiver 202, etc., can establish the SL with the relay UE. For example, local model updating component 242 can determine to establish the SL with the relay UE based on detecting the relay UE within a proximity, based on determining to transmit the model update, etc. In one example, the relay UE can advertise a capability of being a relay UE for transmitting model updates. In this example, local model updating component 242 can determine to establish the SL with the relay UE based on receiving the capability from the relay UE.

In method 400, at Block 408, a report of the model update can be transmitted to the relay UE in SL communications. In an aspect, local model updating component 242, e.g., in conjunction with processor(s) 212, memory 216, transceiver 202, etc., can transmit, to the relay UE in SL communications, a report of the model update. For example, the report of the model update can include the message described above with the various model update parameters and values and/or the other information (e.g., model identifier, hop count, convergence weight, etc.). As described above and further herein, the relay UE can receive model updates from various UEs and can generate an averaged or converged model update for transmitting to an upstream node (e.g., another relay UE or the network via a base station). In an example, local model updating component 242 may send model updates to the relay UE over SL communications and/or to the base station or other network component over uplink communications. In an example, when the relay connection is set, local model updating component 242 can set the source identifier of the message containing the report to an identifier of the scheduled UE and a destination identifier to an identifier of the relay UE.

FIG. 5 illustrates a flow chart of an example of a method 500 for generating and transmitting an averaged model update. In an example, a UE (e.g., UE 104-a, as a relay UE) can perform the functions described in method 400 using one or more of the components described in FIGS. 1 and 2.

In method 500, at Block 502, a report of a model update for a FL model can be received from each of multiple UEs in SL communications. In an aspect, relay model updating component 252, e.g., in conjunction with processor(s) 212, memory 216, transceiver 202, etc., can receive, from each of multiple UEs in SL communications, a report of a model update for a FL model. For example, relay model updating component 252 can receive the reports of model updates from the UEs as including a message described above, which can include one or more model parameters and corresponding values or other information (e.g., a model identifier, hop count, convergence weight, etc.). In an example, relay model updating component 252 can receive the reports from multiple UEs at a similar time, which may be based on a time, trigger, or event detected by the multiple UEs, as described, or may be based on a request from the relay UE or base station, etc.

In method 500, at Block 504, a converged model update can be generated based on one or more parameters in the report of the model update received from each of the multiple UEs. In an aspect, relay model updating component 252, e.g., in conjunction with processor(s) 212, memory 216, transceiver 202, etc., can generate, based on the one or more parameters in the report of the model update received from each of the multiple UEs, the converged model update. For example, relay model updating component 252 can determine how to converge the model update reports from the various UEs such to send a single converged report upstream, which can conserve uplink resources associated with transmitting FL model updates. In one example, the converged model update report may include the real values for the one or more parameters as received in local model update reports from each of the multiple UEs. In other examples, the values can be modified or otherwise represented as described herein.

In an example, in generating the converged model update at Block 504, optionally at Block 506, a convergence weight can be applied to values of the one or more parameter in the report. In an aspect, relay model updating component 252, e.g., in conjunction with processor(s) 212, memory 216, transceiver 202, etc., can apply the convergence weight to values of the one or more parameter in the report. For example, the convergence weight may be indicated in the report, and relay model updating component 252 can determine whether to apply the convergence weight to values of certain parameters. In another example, relay model updating component 252 may determine the convergence weight for the given UE from which the report is received based on one or more other parameters of the UE (e.g., an amount of training data received from the UE, proximity of the UE to the relay UE, subscriber-related parameters, etc.), and may apply the convergence weight to values of one or more of the parameters.

In another example, in generating the converged model update at Block 504, optionally at Block 508, an averaged value for the one or more parameters can be determined. In an aspect, relay model updating component 252, e.g., in conjunction with processor(s) 212, memory 216, transceiver 202, etc., can determine the averaged value for the one or more parameters. For example, relay model updating component 252 can average the value of the one or more parameters as received in the report, average the value of the one or more parameters having applied the convergence weight, etc. In one example, the converged model update can be generated to include the averaged value for the one or more parameters.

In another example, in generating the converged model update at Block 504, optionally at Block 510, one or more relative values can be determined for the one or more parameters. In an aspect, relay model updating component 252, e.g., in conjunction with processor(s) 212, memory 216, transceiver 202, etc., can determine one or more relative values for the one or more parameters. For example, the one or more relative values can be relative to the original value in the base FL model transmitted by the base station, relative to the determined averaged value (e.g., from Block 508), etc. For example, relay model updating component 252 can determine a difference between a value reported for the one or more parameters in a given report received from a UE and the original or averaged value. In an example, relay model updating component 252 can generate the converged model update to include the relative values for the one or more parameters for multiple ones of the UEs. This can allow a base station receiving the converged model update to receive more granular model update results than just averaged values. In an example, relay model updating component 252 can also generate the converged model update to indicate a number of bits used for the relative values, which can allow for using less bits where the relative values are within a certain range of the average. For example, in the message, relay model updating component 252 may include another parameter indicated the quantization bit-width of the values. For example, default can be float 32 bits, or it also could be fixed 16 bits or 8 bits. The indicated quantization bit-width may be model-based, layer-based, or parameter-based. For example, model-based bit-width is with the same bit-width quantization for the whole model. For example, layer-based means that each layer is with one specific bit-width quantization.

In another example, in generating the converged model update at Block 504, optionally at Block 512, a hop count associated with the model update can be decremented. In an aspect, relay model updating component 252, e.g., in conjunction with processor(s) 212, memory 216, transceiver 202, etc., can decrement the hop count associated with the model update. In an example, relay model updating component 252 can include the decremented hop count in the converged model update. In one example, where multiple hop counts are received, relay model updating component 252 can include the smallest hop count, as decremented, in the converged model update. In another example, if the hop count is zero (e.g., where the model update from the UE hopped too many relay UEs), relay model updating component 252 may determine not to include the report in the converged model update.

In method 500, at Block 514, the converged model update can be transmitted to an upstream node. In an aspect, relay model updating component 252, e.g., in conjunction with processor(s) 212, memory 216, transceiver 202, etc., can transmit the converged model update to the upstream node (e.g., another relay UE, a base station or other network component, etc.). For example, relay model updating component 252 can transmit the converged model update to the base station 102 so the converged model update can be applied to the global FL model. In another example, relay model updating component 252 can transmit the converged model update to another relay for further convergence with other model updates (e.g., model updates from other UEs and/or converged model updates from other relay UEs).

In this example, the relay UE can make the model averaging for all the received updated models. For example, for the same model index, where there are three updated models {\hat{M}₀⁰, \hat{M}₀¹, \hat{M}₀²} from three scheduled UEs, and the corresponding convergence weights are {∂₀, ∂₁, ∂₂}, relay model updating component 252 can perform model averaging based on the equation: M₁⁰=(∂₀\hat{M}₀⁰+∂₁\hat{M}₀¹+∂₂\hat{M}₀²)/(∂₀+∂₁+∂₂), where M₀¹ is the final updated model from the relay UE. Such local averaging operations largely merge multiple models into only one, which can largely reduce the resource cost for the model reporting.

With the converged model update, the relay model updating component 252 can transmit the message from the relay UE to the network using uplink Uu interface (e.g., unicast transmission). For example, the message can be configured as one RRC message, and the content of the message can include one or more of the model index, the converged or averaged model parameters and the corresponding values, convergence weight, user index of the scheduled UEs and/or a number (or count) of the scheduled and averaged UEs, etc. In one example, the message may have a format similar to the following:

```
RL message from relay UE:
{....
        Model index: N bit, optional [0,1,2,3..]
        Parameters:
          {first conv layer: values,
          second conv layer: values,
          ...
          first FL layers: values,
          ...}
        Convergence weight: N bit, optional[1,2,3,..]
        User index: {UE ID-1, UE ID-2,...}
        number of User: N bit, optional [1,2,3..]
....}
```

where some parameters can be similar to those described above, and also including the User index or number of the scheduled and averaged users. If the model updates from UEs with identifiers 1, 2, 3 are sent and averaged at the relay UE, the corresponding User index can include 1, 2, 3, and/or the number of Users can be 3, which means that the averaged model is based on 3 updated models.

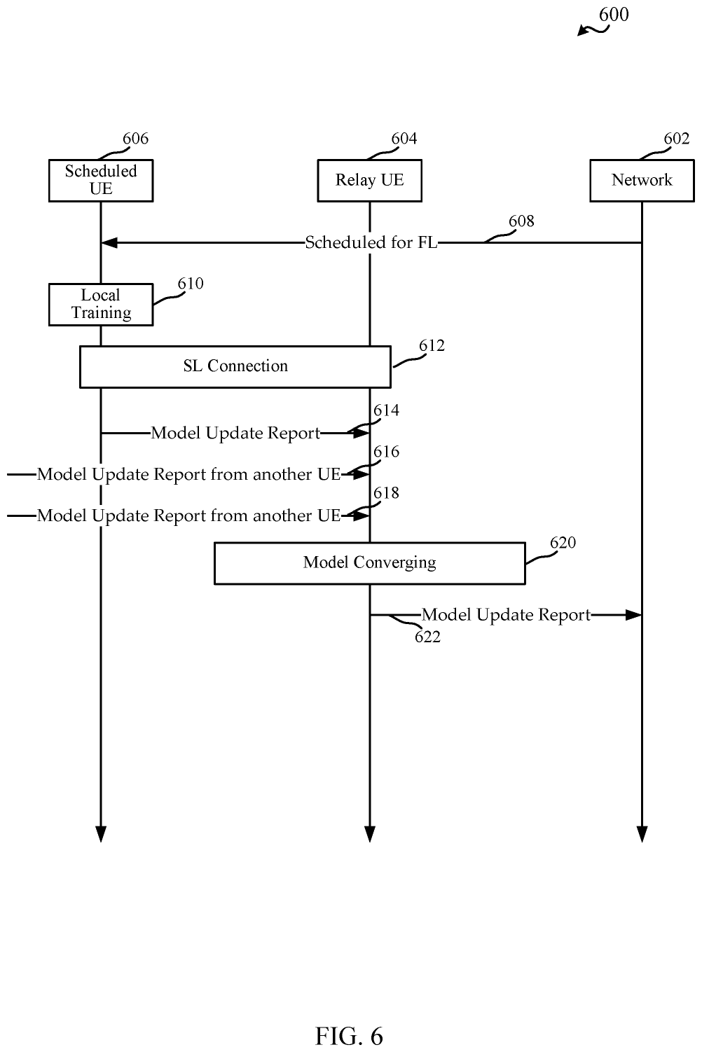

FIG. 6 depicts an example of a call flow 600 between various nodes in a wireless network, in accordance with aspects described herein. Call flow 600 includes a network 602, relay UE 604, and scheduled UE 606. The network 602 (e.g., via a base station) can schedule a scheduled UE 606 for FL at 608, which may include sending the base FL model to the scheduled UE 606. Scheduled UE 606 can perform local training on the FL model at 610. In addition, scheduled UE 606 can establish SL connection with the relay UE 604 at 612. As described, scheduled UE 606 may establish the SL connection based on determining to transmit a model update or based on other triggers or events. Scheduled UE 606 can transmit a model update report to the relay UE 604 at 614. As described, for example, scheduled UE 606 can transmit the model update report to the relay UE 604 after a period of time, based on one or more triggers or other events, which may be indicated by the network 602 in scheduling the scheduled UE 606 for FL at 608, based on a request from the network 602 or relay UE 604, etc. Relay UE 604 can receive additional model update reports from other UEs at 616 and 618. Relay UE 604 can perform model converging at 620, and can transmit a model update report with the converged model update to the network 602 at 622.

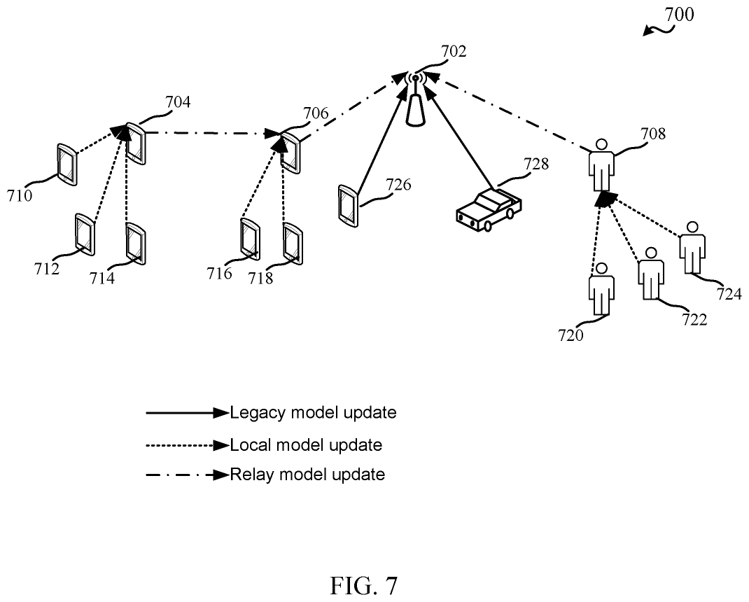

FIG. 7 depicts an example of a wireless network 700 for FL model updating, in accordance with aspects described herein. Wireless network 700 includes a base station 702 that can receive relay model updates as converged from relay UEs 704, 706 or user 708. Relay UE 704 can receive local model updates from UEs 710, 712, 714 and can converge the local model updates into a relay model update for transmitting by relay UE 704 to relay UE 706. Relay UE 706 can also receive local model updates from UEs 716, 718 and can converge the local model updates into a relay model update for transmitting by relay UE 706 to base station 702. Relay UE 706 can also transmit the relay model update from relay UE 704 to base station 702 and/or can further converge the relay model update from relay UE 704 into the relay model update converged from local model updates of UEs 716, 718. Similarly, user 708 can converge local model updates from users 720, 722, 724 into a relay model update for transmitting to the base station 702. In addition, for example, UE 726 and vehicle 728 may perform legacy model updates directly to the base station 702 without traversing a relay node.

FIG. 8 is a block diagram of a MIMO communication system 800 including a base station 102 and a UE 104, in accordance with various aspects of the present disclosure. The MIMO communication system 800 may illustrate aspects of the wireless communication access network 100 described with reference to FIG. 1. The base station 102 may be an example of aspects of the base station 102 described with reference to FIG. 1. In addition, the UE 104 can communicate with another UE over sidelink resources using similar functionality described herein with respect to UE 104 and base station 102 communications, and as such, base station 102 could be another UE 104 having a local model updating component 242 or relay model updating component 252.

The base station 102 may be equipped with antennas 834 and 835, and the UE 104 may be equipped with antennas 852 and 853. In the MIMO communication system 800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 820 may receive data from a data source. The transmit processor 820 may process the data. The transmit processor 820 may also generate control symbols or reference symbols. A transmit MIMO processor 830 may perform spatial processing (e.g., precoding) on data symbols, control symbols, or reference symbols, if applicable, and may provide output symbol streams to the transmit modulator/demodulators 832 and 833. Each modulator/demodulator 832 through 833 may process a respective output symbol stream (e.g., for OFDM, etc.) to obtain an output sample stream. Each modulator/demodulator 832 through 833 may further process (e.g., convert to analog, amplify, filter, and upconvert) the output sample stream to obtain a DL signal. In one example, DL signals from modulator/demodulators 832 and 833 may be transmitted via the antennas 834 and 835, respectively.

The UE 104 may be an example of aspects of the UEs 104 described with reference to FIGS. 1-2. At the UE 104, the UE antennas 852 and 853 may receive the DL signals from the base station 102 and may provide the received signals to the modulator/demodulators 854 and 855, respectively. Each modulator/demodulator 854 through 855 may condition (e.g., filter, amplify, downconvert, and digitize) a respective received signal to obtain input samples. Each modulator/demodulator 854 through 855 may further process the input samples (e.g., for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor 858 may process (e.g., demodulate, deinterleave, and decode) the detected symbols, providing decoded data for the UE 104 to a data output, and provide decoded control information to a processor 880, or memory 882.

The processor 880 may in some cases execute stored instructions to instantiate a local/relay model updating component 890, which can include a local model updating component 242 and/or a relay model updating component 252 (see e.g., FIGS. 1 and 2).

On the uplink (UL), at the UE 104, a transmit processor 864 may receive and process data from a data source. The transmit processor 864 may also generate reference symbols for a reference signal. The symbols from the transmit processor 864 may be precoded by a transmit MIMO processor 866 if applicable, further processed by the modulator/demodulators 854 and 855 (e.g., for SC-FDMA, etc.), and be transmitted to the base station 102 in accordance with the communication parameters received from the base station 102. At the base station 102, the UL signals from the UE 104 may be received by the antennas 834 and 835, processed by the modulator/demodulators 832 and 833, detected by a MIMO detector 836 if applicable, and further processed by a receive processor 838. The receive processor 838 may provide decoded data to a data output and to the processor 840 or memory 842.

The processor 840 may in some cases execute stored instructions to instantiate a configuring component 342 (see e.g., FIGS. 1 and 3).

The components of the UE 104 may, individually or collectively, be implemented with one or more application specific integrated circuits (ASICs) adapted to perform some or all of the applicable functions in hardware. Each of the noted modules may be a means for performing one or more functions related to operation of the MIMO communication system 800. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 800.

The following aspects are illustrative only and aspects thereof may be combined with aspects of other embodiments or teaching described herein, without limitation.
Aspect 1 is a method for wireless communication by a UE including receiving, from each of multiple UEs in sidelink communications, a report of a model update for a federated learning model, generating, based on one or more parameters in the report of the model update received from each of the multiple UEs, a converged model update, and transmitting, to an upstream node, the converged model update.
In Aspect 2, the method of Aspect 1 includes where the report from a given one of the multiple UEs further includes a hop count indicating a number of hops for which the report is valid.
In Aspect 3, the method of Aspect 2 includes decrementing the hop count to determine an updated hop count to include in the converged model update transmitted to the upstream node.
In Aspect 4, the method of any of Aspects 1 to 3 includes where the report from a given one of the multiple UEs further includes a convergence weight, and applying the convergence weight to the one or more parameters in the report from the given one of the multiple UEs in generating the converged model update.
In Aspect 5, the method of any of Aspects 1 to 4 includes where the upstream node is a base station, and transmitting the converged model update includes transmitting the converged model update in a RRC message.
In Aspect 6, the method of Aspect 5 includes where the converged model update includes at least one of a model index of the federated learning model, one or more averaged parameters generated in generating the converged model update, an identifier of the multiple UEs, or a count of the multiple UEs.
In Aspect 7, the method of any of Aspects 1 to 6 includes where the upstream node is another relay UE.
In Aspect 8, the method of any of Aspects 1 to 7 includes where the one or more parameters in the report of the model update received for a given one of the multiple UEs includes a value of a relative difference between a parameter of a global federated learning model and a corresponding parameter of the model update.
In Aspect 9, the method of Aspect 8 includes where the one or more parameters in the report indicate a quantization bit-width of the value of the relative difference.
In Aspect 10, the method of any of Aspects 8 or 9 includes where the value of the relative difference corresponds to a whole model of the model update or to a convolution layer of the model update.
Aspect 11 is a method for wireless communication by a UE including receiving, from a base station, an indication of a federated learning model, generating, for the federated learning model and based on a local training on the federated learning model, a model update to be applied to the federated learning model, and transmitting, to a relay UE in sidelink communication, a report of the model update.
In Aspect 12, the method of Aspect 11 includes where the report of the model update further includes a hop count indicating a number of hops for which the report is valid.
In Aspect 13, the method of any of Aspects 11 or 12 includes where the report further includes a convergence weight to apply to the model update.
In Aspect 14, the method of any of Aspects 11 to 13 includes where the report further includes a source identifier of the UE and a destination identifier of the relay UE.
In Aspect 15, the method of any of Aspects 11 to 14 includes where the report includes a value of a relative difference between a parameter of the federated learning model and a corresponding parameter of the model update.
In Aspect 16, the method of Aspect 15 includes where one or more parameters in the report indicate a quantization bit-width of the value of the relative difference.
In Aspect 17, the method of any of Aspects 15 or 16 includes where the value of the relative difference corresponds to a whole model of the model update or to a convolution layer of the model update.
Aspect 18 is an apparatus for wireless communication including a transceiver, a memory configured to store instructions, and one or more processors communicatively coupled with the memory and the transceiver, where the one or more processors are configured to execute the instructions to cause the apparatus to perform one or more of the methods of any of Aspects 1 to 17.
Aspect 19 is an apparatus for wireless communication including means for performing one or more of the methods of any of Aspects 1 to 17.
Aspect 20 is a computer-readable medium including code executable by one or more processors for wireless communications, the code including code for performing one or more of the methods of any of Aspects 1 to 17.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the memory and the transceiver, wherein the one or more processors are configured to execute the instructions to cause the apparatus to:
receive, from each of multiple user equipment (UEs) in sidelink communications, a report of a model update for a federated learning model;
generate, based on one or more parameters in the report of the model update received from each of the multiple UEs, a converged model update; and
transmit, to an upstream node, the converged model update.

2. The apparatus of claim 1, wherein the report from a given one of the multiple UEs further includes a hop count indicating a number of hops for which the report is valid.

3. The apparatus of claim 2, wherein the one or more processors are further configured to execute the instructions to cause the apparatus to decrement the hop count to determine an updated hop count to include in the converged model update transmitted to the upstream node.

4. The apparatus of claim 1, wherein the report from a given one of the multiple UEs further includes a convergence weight, and wherein the one or more processors are further configured to execute the instructions to cause the apparatus to apply the convergence weight to the one or more parameters in the report from the given one of the multiple UEs in generating the converged model update.

5. The apparatus of claim 1, wherein the upstream node is a base station, and wherein the one or more processors are configured to execute the instructions to cause the apparatus to transmit the converged model update in a radio resource control (RRC) message.

6. The apparatus of claim 5, wherein the converged model update includes at least one of a model index of the federated learning model, one or more averaged parameters generated in generating the converged model update, an identifier of the multiple UEs, or a count of the multiple UEs.

7. The apparatus of claim 1, wherein the upstream node is another relay UE.

8. The apparatus of claim 1, wherein the one or more parameters in the report of the model update received for a given one of the multiple UEs includes a value of a relative difference between a parameter of a global federated learning model and a corresponding parameter of the model update.

9. The apparatus of claim 8, wherein the one or more parameters in the report indicate a quantization bit-width of the value of the relative difference.

10. The apparatus of claim 8, wherein the value of the relative difference corresponds to a whole model of the model update or to a convolution layer of the model update.

11. An apparatus for wireless communication, comprising:
a transceiver;
a memory configured to store instructions; and
one or more processors communicatively coupled with the memory and the transceiver, wherein the one or more processors are configured to execute the instructions to cause the apparatus to:
receive, from a base station, an indication of a federated learning model;
generate, for the federated learning model and based on a local training on the federated learning model, a model update to be applied to the federated learning model; and
transmit, to a relay user equipment (UE) in sidelink communication, a report of the model update.

12. The apparatus of claim 11, wherein the report of the model update further includes a hop count indicating a number of hops for which the report is valid.

13. The apparatus of claim 11, wherein the report further includes a convergence weight to apply to the model update.

14. The apparatus of claim 11, wherein the report further includes a source identifier of the UE and a destination identifier of the relay UE.

15. The apparatus of claim 11, wherein the report includes a value of a relative difference between a parameter of the federated learning model and a corresponding parameter of the model update.

16. The apparatus of claim 15, wherein one or more parameters in the report indicate a quantization bit-width of the value of the relative difference.

17. The apparatus of claim 15, wherein the value of the relative difference corresponds to a whole model of the model update or to a convolution layer of the model update.

18. A method for wireless communication by a user equipment (UE), comprising:
receiving, from each of multiple UEs in sidelink communications, a report of a model update for a federated learning model;
generating, based on one or more parameters in the report of the model update received from each of the multiple UEs, a converged model update; and
transmitting, to an upstream node, the converged model update.

19. The method of claim 18, wherein the report from a given one of the multiple UEs further includes a hop count indicating a number of hops for which the report is valid.

20. The method of claim 19, further comprising decrementing the hop count to determine an updated hop count to include in the converged model update transmitted to the upstream node.

21. The method of claim 18, wherein the report from a given one of the multiple UEs further includes a convergence weight, and further comprising applying the convergence weight to the one or more parameters in the report from the given one of the multiple UEs in generating the converged model update.

22. The method of claim 18, wherein the upstream node is a base station, and wherein transmitting the converged model update includes transmitting the converged model update in a radio resource control (RRC) message.

23. The method of claim 22, wherein the converged model update includes at least one of a model index of the federated learning model, one or more averaged parameters generated in generating the converged model update, an identifier of the multiple UEs, or a count of the multiple UEs.

24. The method of claim 18, wherein the upstream node is another relay UE.

25. The method of claim 18, wherein the one or more parameters in the report of the model update received for a given one of the multiple UEs includes a value of a relative difference between a parameter of a global federated learning model and a corresponding parameter of the model update.

26. The method of claim 25, wherein the one or more parameters in the report indicate a quantization bit-width of the value of the relative difference.

27. The method of claim 25, wherein the value of the relative difference corresponds to a whole model of the model update or to a convolution layer of the model update.

28. A method for wireless communication by a user equipment (UE), comprising:
receiving, from a base station, an indication of a federated learning model;
generating, for the federated learning model and based on a local training on the federated learning model, a model update to be applied to the federated learning model; and
transmitting, to a relay UE in sidelink communication, a report of the model update.

29. The method of claim 28, wherein the report of the model update further includes a hop count indicating a number of hops for which the report is valid.

30. The method of claim 28, wherein the report further includes a convergence weight to apply to the model update.
